(19) United States
(12) Patent Application Publication
(10) Pub. No.: US 2007/0050718 A1
(43) Pub. Date: Mar. 1, 2007

(54) Systems and methods for web server based media production

(76) Inventors: Michael R. Moore, Folsom, CA (US); Daniel A. Kaye, Folsom, CA (US); Kenneth A. Turcotte, Folsom, CA (US); Michael D. Wang-Helmke, Carmichael, CA (US); Peter A. Tjeerdsma, Fair Oaks, CA (US); Christopher H. Davey, Sacramento, CA (US)

Correspondence Address: CARR & FERRELL LLP, 2200 GENG ROAD, PALO ALTO, CA, 94303, US

(21) Appl. No.: 11/437,207

(22) Filed: May 19, 2006

Related U.S. Application Data
(60) Provisional application No. 60/682,371, filed on May 19, 2005.
(60) Provisional application No. 60/715,003, filed on Sep. 7, 2005.

(51) Int. Cl. G06F 3/00

(52) U.S. Cl. 715/744; 715/908

(57) ABSTRACT

Exemplary systems and methods for web server based media production are provided. A server provides programming functionality to a client via a browser plug-in or other similar plug-in. The server is comprised of a digital media engine, which is further comprised of multiple modules that provide the programming functionality to the client via the browser plug-in. The processing power of the client is leveraged to author and produce a media production. User-supplied media content files and content theme settings are transmitted from the server to produce a media production.

### CROSS-REFERENCE TO RELATED APPLICATIONS

The present application claims the benefit and priority of U.S. Provisional Patent Application Ser. No. 60/682,371 filed on May 19, 2005 and entitled “A User Interface and Theme-based Content Template Design for the Automated Authoring, Production, and Delivery of Multiple Forms of Digital Media,” which is herein incorporated by reference; the present application also claims the benefit and priority of U.S. Provisional Patent Application Ser. No. 60/715,003 filed on Sep. 7, 2005 and entitled “Dynamic Content Production Based on Associated Metadata,” which is also herein incorporated by reference.

### BACKGROUND OF THE INVENTION

1. Field of the Invention

The present invention relates generally to media production, and more particularly, to media production using web servers.

2. Description of Related Art

Existing tools for authoring and producing media content are typically standalone applications, such as personal-computer (“PC”) software and are often bundled with such things as digital cameras. These tools suffer from one or more of the following drawbacks:

Complex hardware and software installation and configuration procedures;

High level of complexity requiring user expertise in authoring media content and producing media productions; and

High degree of artistic talent required to author media content and produce media productions commensurate with the quality of work that a highly skilled professional in the field of media content authoring and media production would produce. There is therefore a need for systems and methods for web server based media production.

### BRIEF SUMMARY OF THE INVENTION

Exemplary systems and methods for web server based media production are provided. Exemplary systems include a web server configured with a digital media engine, the digital media engine configured with a media content default theme template module configured to provide at least one default theme template to media content, a client with the media content and connected through an Internet connection to the web server, the client configured to display the media content with the at least one default theme template provided by the media content default theme module, and the client configured to transmit to the web server a media content file with media content theme settings. Further systems include the digital media engine configured with a media content resolution module configured to adjust resolution of the media content to accommodate a client display device.

Exemplary methods include media production by selecting media content on a client, providing one or more default themes to the media content, selecting a media production format for the media content and transmitting the media content in a file with media content theme settings to a web server to produce a media production. Other methods comprise editing the media content with a graphical user interface and viewing the edited media content on a client display device.

### BRIEF DESCRIPTION OF THE DRAWINGS

FIG. 1 shows a simplified architecture in which embodiments of the present invention are practiced;

FIG. 2 shows a server and client configured to operate with each other over a network;

FIG. 3 shows an exemplary flowchart for authoring and producing a web server based media production;

FIG. 4 shows an exemplary flowchart for the application of media content default theme templates to a photo book;

FIG. 5 shows an exemplary flowchart for the application of media content default theme templates to a photo movie DVD or web slide show;

FIG. 6 shows an exemplary photo movie DVD creation graphical user interface;

FIG. 7 shows an exemplary photo movie DVD add music graphical user interface;

FIG. 8 shows an exemplary photo movie DVD order graphical user interface;

FIG. 9 shows an exemplary photo movie DVD editing graphical user interface;

FIG. 10 shows an exemplary photo movie DVD photo motion control graphical user interface;

FIG. 11 shows an exemplary photo movie DVD text title control graphical user interface;

FIG. 12 shows an exemplary photo book creation graphical user interface; and

FIG. 13 shows an exemplary photo book page style graphical user interface.

### DETAILED DESCRIPTION OF THE INVENTION

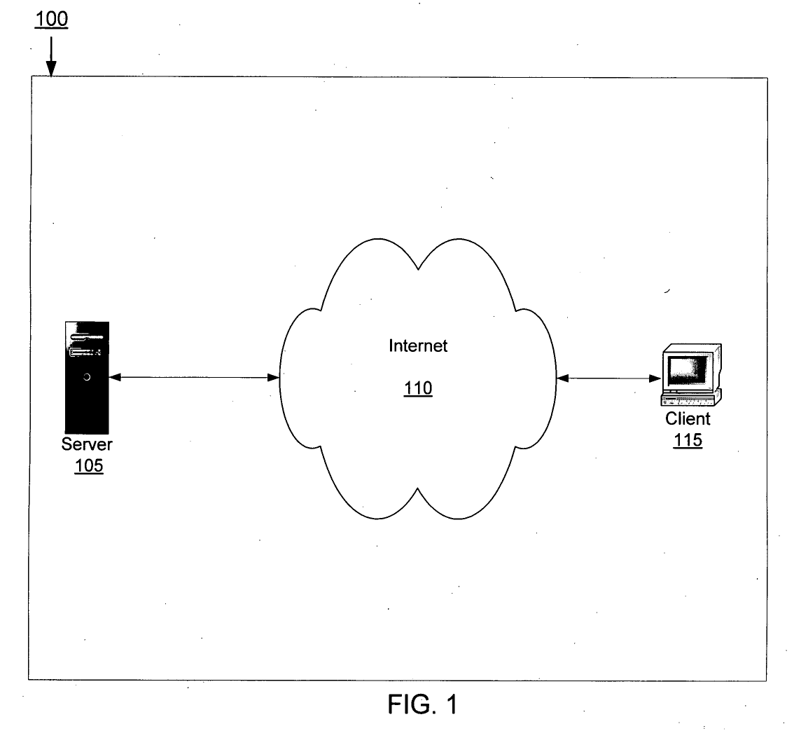

FIG. 1 shows a simplified architecture 100 in which embodiments of the present invention are practiced. Shown in FIG. 1 are a server 105 connected to a client 115 by an Internet 110 for web server based media production. Internet 110 includes the World Wide Web. A media production is a photo book, photo movie DVD, web slide show, streaming media, or any other production comprised of media content. A photo movie DVD is a multi-format video DVD that can be played on a standard DVD player, and the photo movie DVD can comprise video clips combined with still photos using pan and zoom motions and other visual effects, and can also contain archived high resolution photos in a computer-readable format. Media content can include audio, video, audiovisual, pictorial, photographic, all image forms, text files, and all variations and combinations thereof. Although FIG. 1 shows only one client and one server, it should be understood that embodiments of the present invention can include numerous clients and one or more servers.

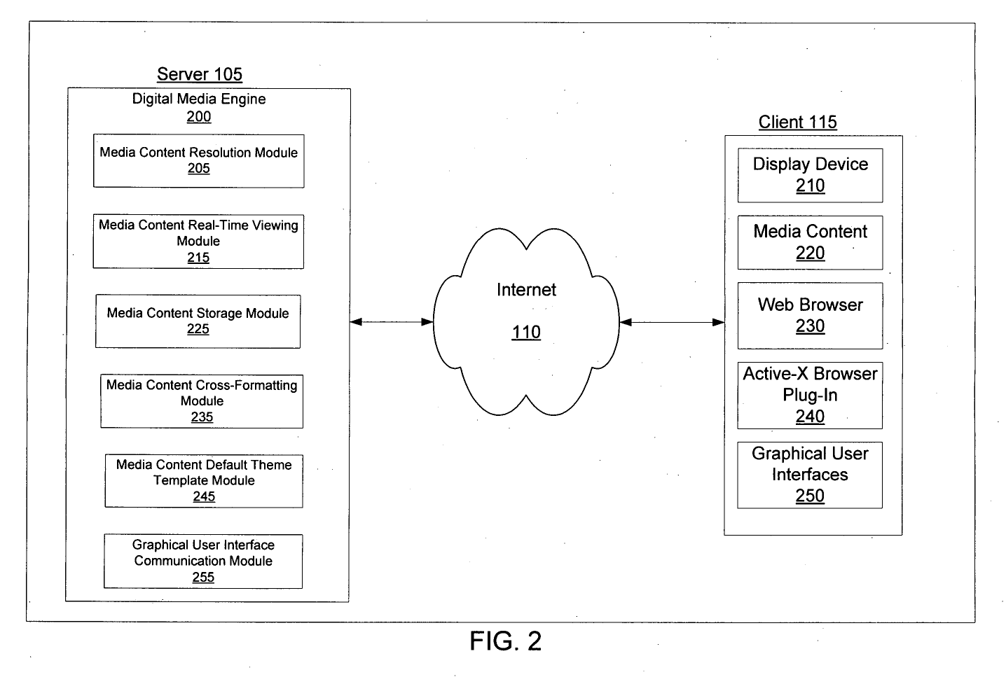

FIG. 2 shows a server 105 and client 115 configured to operate with each other over the Internet 110. The server 105 comprises an exemplary digital media engine 200. The exemplary digital media engine 200 further comprises a media content resolution module 205, a media content real-time viewing module 215, a media content storage module 225, a media content cross-formatting module 235, a media content default theme template module 245, and a graphical user interface communication module 255. The client 115 comprises a display device 210, media content 220, a web browser 230, an Active-X browser plug-in 240, and graphical user interfaces 250.

The server 105 provides programming functionality to the client 115 via the Active-X browser plug-in 240. The server 105 is comprised of the digital media engine 200, which is further comprised of the multiple modules described herein that provide the programming functionality to the client 115 via the Active-X browser plug-in 240. The Active-X browser plug-in 240 contains the programming functionality of the digital media engine 200 and the multiple modules that comprise the digital media engine 200. The processing power of the client 115 is leveraged to author and produce a media production. User-supplied media content files and content theme settings are transmitted from the client 115 to the server 105 to produce a media production.

An alternative embodiment can include the flexibility to install a complete application (including components that would otherwise be found on a server) on a standalone client such as a kiosk or mobile system. Such an installation may also include support for the standalone client making periodic connections to a network, not limited to the Internet, in order to transmit media content files and content theme settings to a server and/or production facility.

The server 105 is configured to operate with the client 115 over the Internet 110. The server 105 can be an Internet accessible server, such as an Apache or Microsoft IIS. The server 105 is configured with the digital media engine 200. The digital media engine 200 communicates with the client 115 over the Internet 110 through one or more graphical user interfaces 250 that appear on the display device 210 of the client 115. Advantageously, because the digital media engine 200 resides on the server 105, programming updates can be made to the digital media engine 200 and transmitted to the client 115 without the client 115 being required to manually install and/or configure a new or updated client application.

The digital media engine 200 can detect the connection speed and display resolution of the client 115. The processing power of the client 115 is leveraged to author and produce as much of a media production as possible. For example, efficiency is optimized by the client 115 having responsibility for high quality media content 220 processing. Additionally, user-supplied media content files and chosen media content theme settings describing the desired media production are transmitted from the client 115 over the Internet 110 to the server 105. For example, the client 115 transmits descriptions of media content 220 motions rather than the final animated frames. By the client 115 only transmitting the user-supplied media content files and chosen media content theme settings, network bandwidth is conserved. For example, in the case of a photo book media production, items of media content 220 are composited together on photo book pages before being transmitted by the client 115 to the server 105. In one embodiment, composited photo book pages can be transmitted as individual media content files such as JPEG, or in a single file such as a PDF ready for printing. Additionally, book cover and binding description data can be transferred in a variety of forms such as XML or other machine readable data formats.

The digital media engine 200 is configured with a media content resolution module 205. The media content resolution module 205 triggers a display to be processed by a client that can be viewed on a wide variety of client display devices, such as display device 210. The media content resolution module 205 can include, when appropriate, size reduction and/or compression of media content 220.

A media content real-time viewing module 215 forms part of the digital media engine 200. The real-time viewing module 215 enables the user to view on the display device 210 of the client 115 the effect of each command and/or menu option executed by the user via the graphical user interfaces 250 as applied to the media content 220. The media content real-time viewing module 215 leverages the client 115 for the processing power required for real-time viewing.

The digital media engine 200 is configured with a media content storage module 225. The media content storage module 225 stores the user-supplied media content files and chosen media content theme settings as directed by the user via the graphical user interfaces 250.

A media content cross-formatting module 235 forms part of the digital media engine 200. The media content cross-formatting module 235 applies the information stored in the media content storage module 225 with respect to one particular form of a media production such as a photo movie DVD to produce a second form of a media production such as a photo book or web slide show. For example, the size that a user selects for a particular item of media content 220 in a photo book can be used by the media content cross-formatting module 235 as an indicator of the importance of the particular item of media content 220 to the user. Accordingly, the media content cross-formatting module 235 will associate with the indicator such parameters as the duration in time that the particular item of media content 220 should appear within a photo movie DVD or web slide show.

As a second example of the operation of the media content cross-formatting module 235, the relative size of a text title used in connection with a particular item of media content 220 can be used by the media content cross-formatting module 235 as an indicator of the importance of the particular item of media content 220 to the user. Accordingly, the media content cross-formatting module 235 can associate with the indicator a relative size or placement order for the particular item of media content 220 compared to other items of media content 220 appearing in a media production.

The digital media engine 200 is configured with a media content default theme template module 245. The media content default theme template module 245 provides default theme templates to the media content 220. As explained further herein, the default theme templates are sets of predefined aesthetically pleasing elements that are automatically applied to media content 220 to create a media production. In one embodiment, the transfer of default theme templates is optimized for installation simplicity. For example, the default theme templates are stored on a server and retrieved by a web client when required, minimizing client installation requirements. In an alternative embodiment, the default theme templates are stored on the client, thus optimizing access time and bandwidth usage.

A graphical user interface communication module 255 that forms part of the digital media engine 200 provides graphical user interfaces 250 that appear on the display device 210 of the client 115. The graphical user interfaces 250 are implemented on the client 115 using a combination of dynamic HTML and Active-X components to present commands, menu options and system status to the user in an aesthetically pleasing and easily understandable format.

Referring again to FIG. 2, in one embodiment, the client 115 is a personal computer with the display device 210. The client 115 can also be a cellular phone, kiosk, and/or personal digital assistant (“PDA”). Further, the client 115 is operated by one or more human users, collectively referred to herein as the “user.”

The client 115 is configured with the web browser 230 such as Internet Explorer, Netscape Navigator, Firefox, Safari, and/or Mozilla. The client 115 is also configured with the Active-X browser plug-in 240. Other browser plug-ins can include Netscape Navigator plug-in or other similar plug-ins and applications. The client 115 is further configured to store the media content 220. The client 115 communicates with the server 105 by a set of commands and/or menu options contained on the graphical user interfaces 250 that appear on the display device 210 of the client 115.

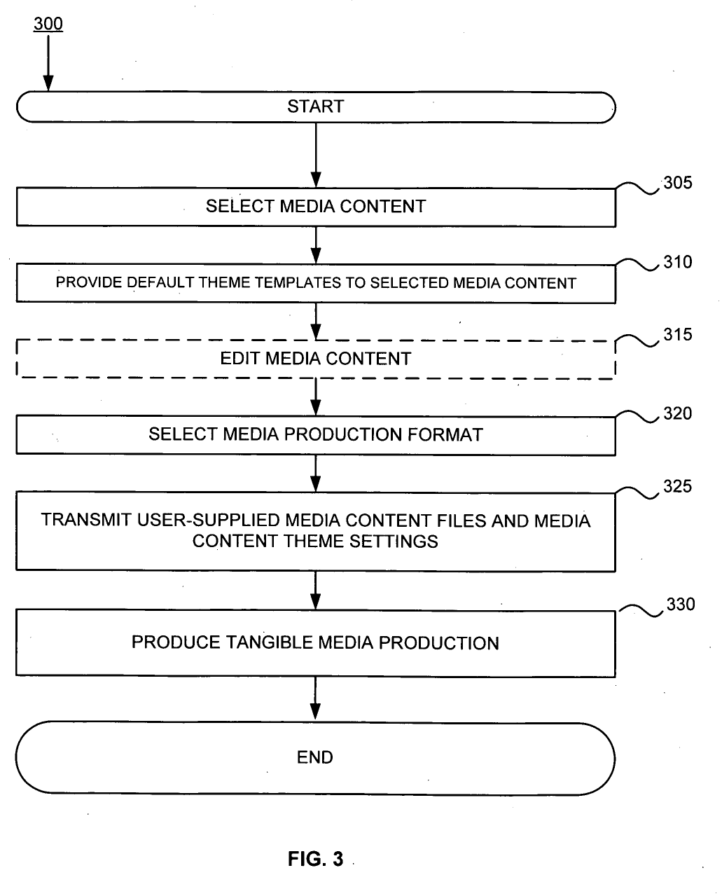

FIG. 3 shows an exemplary flowchart 300 for authoring and producing a web server based media production. A user starting with a collection of media content 220 (FIG. 2) can produce a professional-quality media production without the requisite expertise for a professional quality media production.

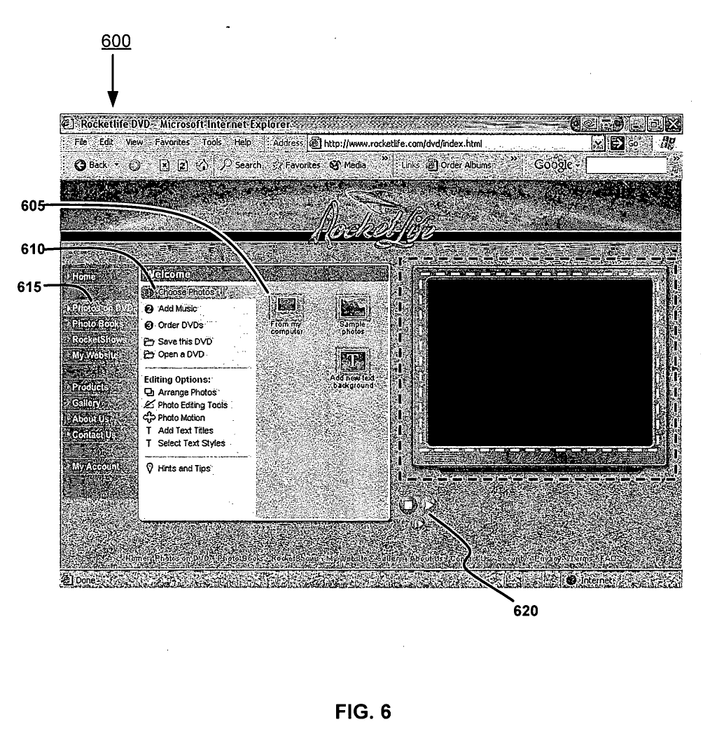

At step 305, the user selects the media content 220 to be used in the media production. For example, in FIG. 6, the photo movie DVD creation graphical user interface 600 includes media content selection icons 605 that allow a user to select media content 220 to be included in a media production.

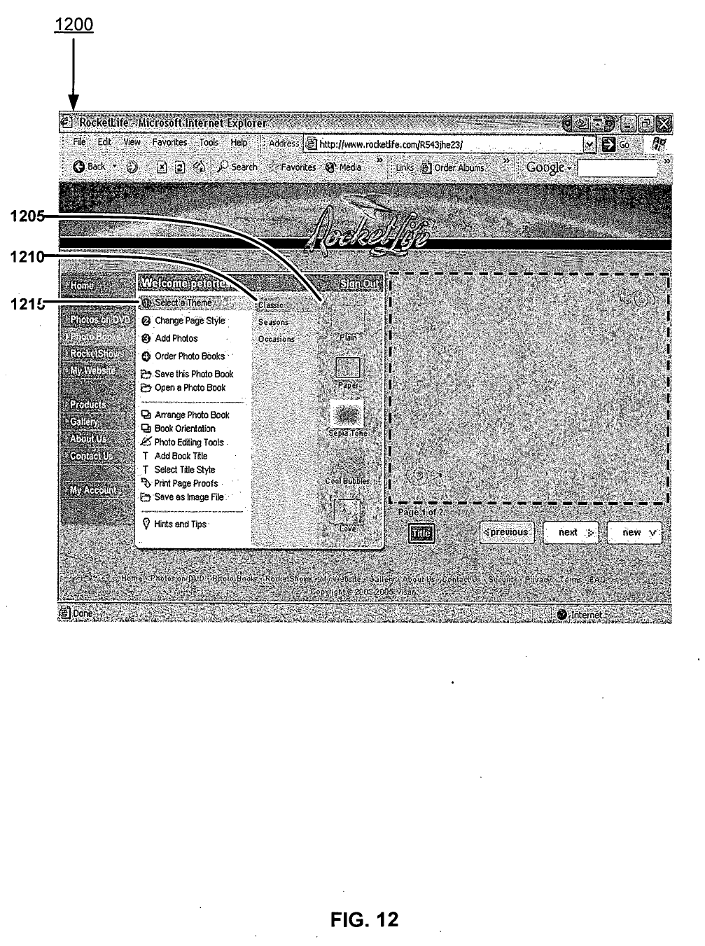

At step 310, a media content default theme template module 245 (FIG. 2) provides a predefined set of aesthetically pleasing default theme templates to the media content selected at step 305. Default theme templates include a default page layout, a default page background effect, a default text format, a default book page arrangement, a default music selection, a default sequence timing, a default transition type, a default photo motion path, a default motion timing, a default title appearance, a default frame border, and/or a default “show energy” effect. For example, in FIG. 12, the photo book creation graphical user interface 1200 allows a user to create a photo book media production by presenting the user with a number of menu options and/or commands for selecting a theme for a photo book. The photo book creation graphical user interface 1200 includes a theme menu option 1215, and theme category submenu options 1210, permitting the user to replace a default theme as a whole using a single command, selecting from a variety of alternative themes for a particular media production such as “birthday,” “vacation,” or “travel” themes.

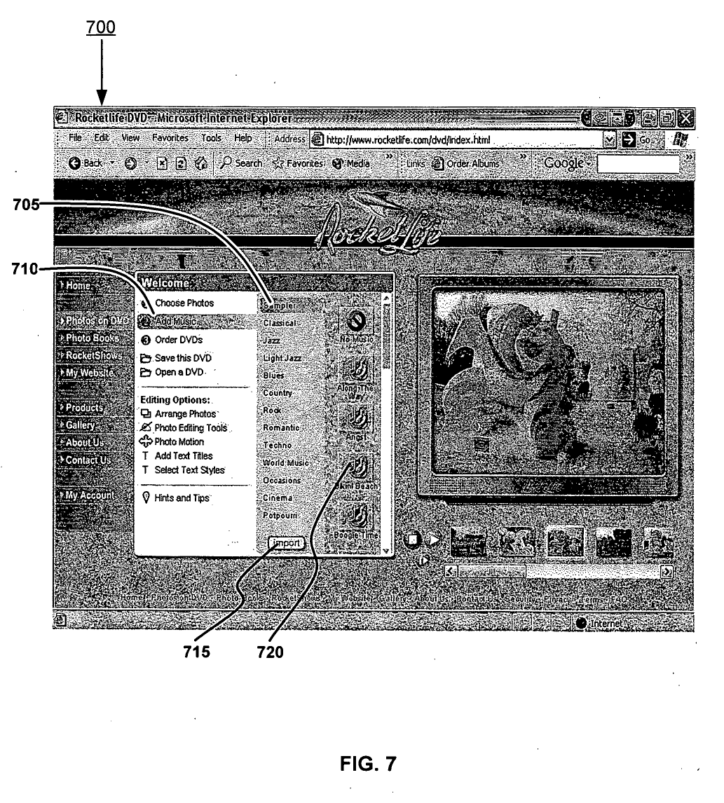

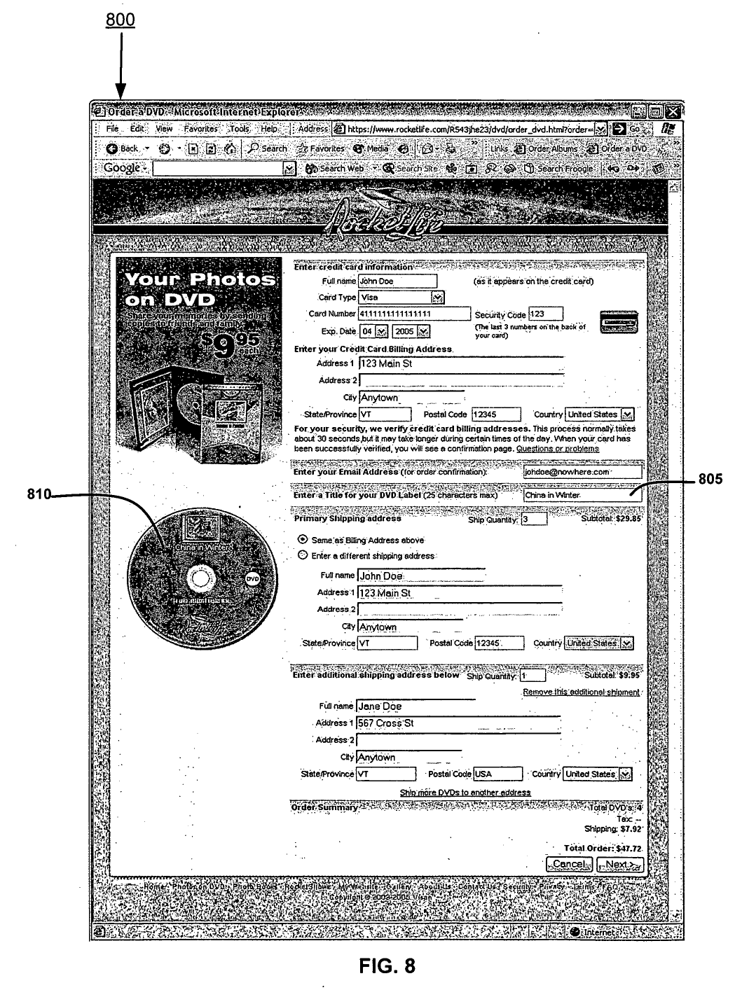

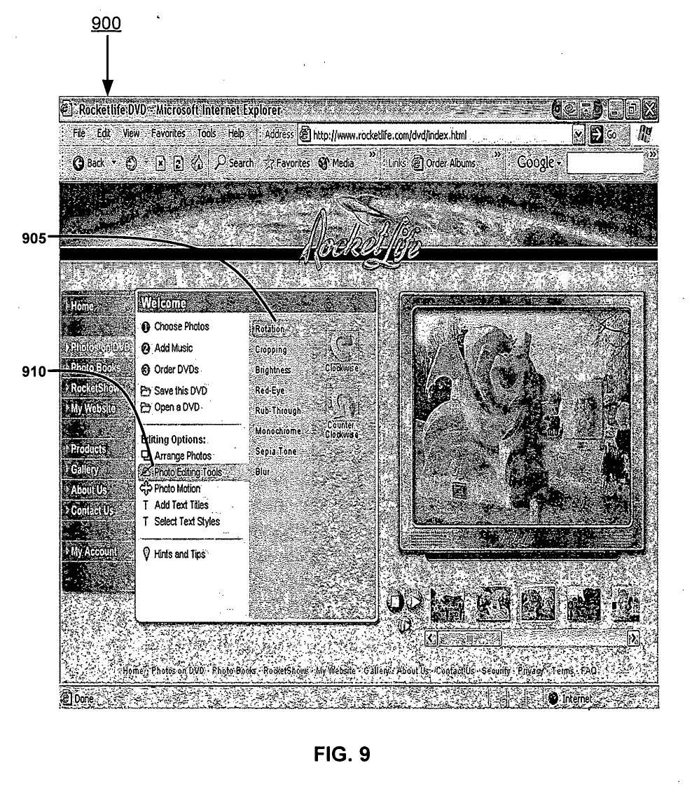

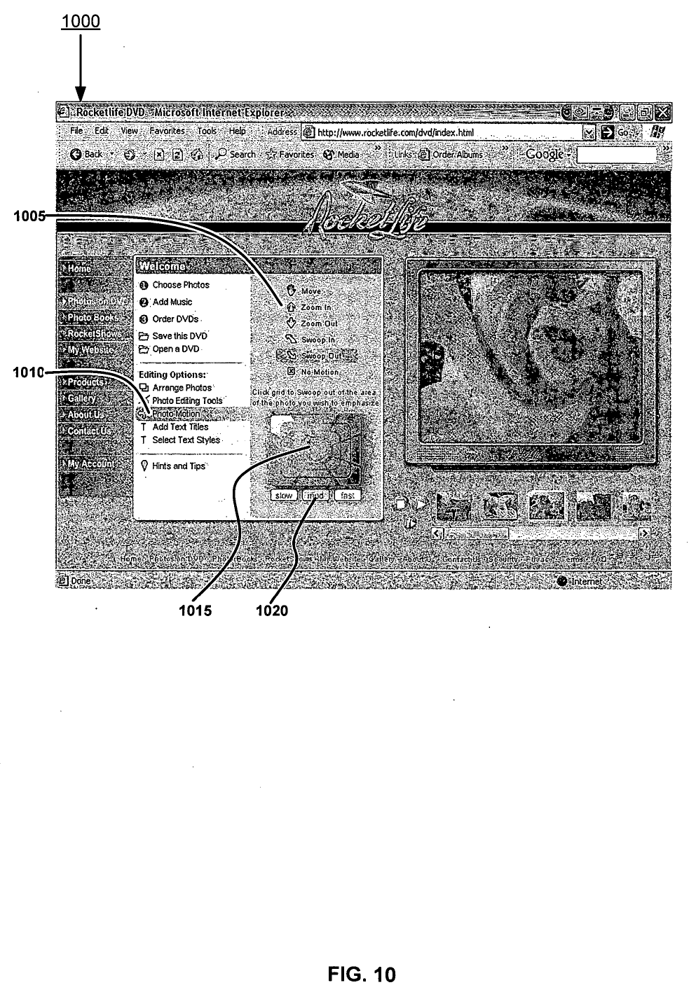

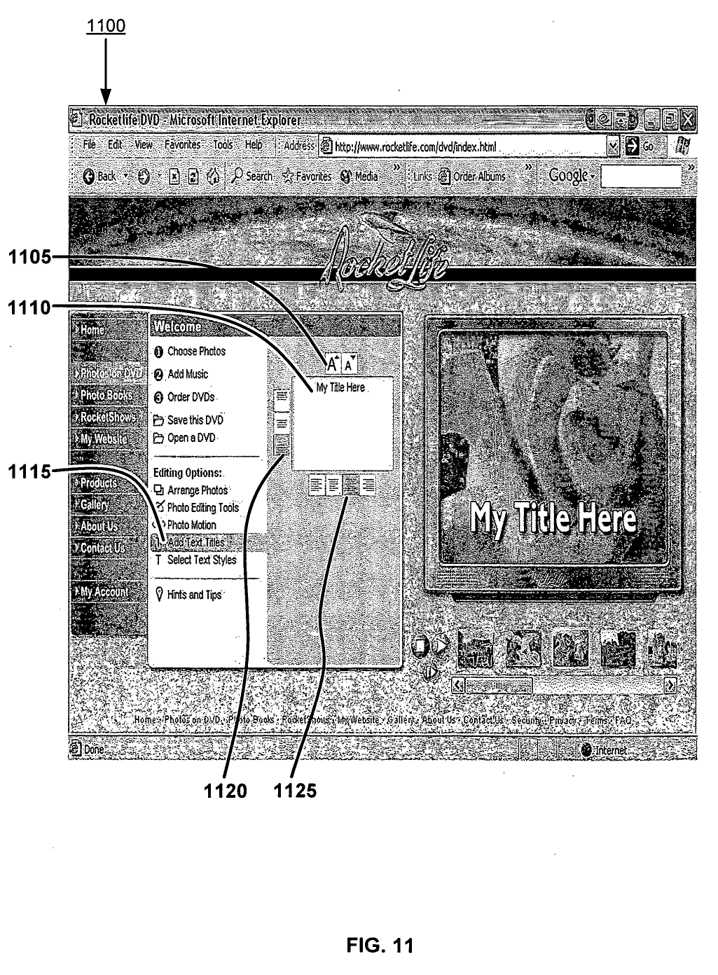

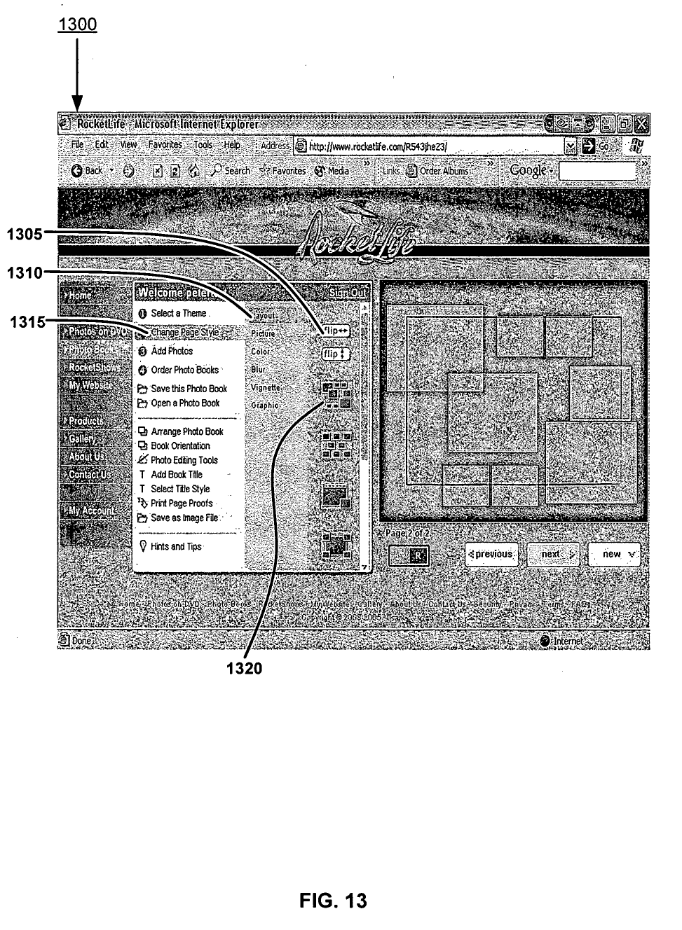

At step 315, the user optionally edits the media content 220 forming the media production by executing commands and/or electing menu options via one or more graphical user interfaces 250 (FIG. 2). Exemplary graphical user interfaces include (however are not limited to) a photo movie DVD creation graphical user interface 600 (FIG. 6); a photo movie DVD add music graphical user interface 700 (FIG. 7); a photo movie DVD order graphical user interface 800 (FIG. 8); a photo movie DVD editing graphical user interface 900 (FIG. 9); a photo movie DVD photo motion control graphical user interface 1000 (FIG. 10); a photo movie DVD text title control graphical user interface 1100 (FIG. 11); a photo book creation graphical user interface 1200 (FIG. 12); and a photo book page style graphical user interface 1300 (FIG. 13). For example, in FIG. 9, a user could use the photo movie DVD media production editing graphical user interface 900 to edit media content 220. For example, the user can select rotation editing menu option 905 to rotate an item of media content 220.

Further, the digital media engine 200 is configured with a media content real-time viewing module 215 (FIG. 2). The real-time viewing module 215 allows the user to view on the display device 210 (FIG. 2) of the client 115 (FIG. 1) the effect of each command and/or menu option executed by the user via the graphical user interfaces 250 as applied to the media content 220, rendered on the client 115 by the Active-X plug-in 240. Thus, the user has an almost instant real-time view of the media content 220 and an almost instant real-time preview of the media production as the user continues to work on the media production.

At step 320, the user selects a media production format. Media production formats include a print format photo book, a video format photo movie DVD, a streaming web slide show format, or any other production format comprised of media content 220. For example, in FIG. 6, a user selects the photos on DVD menu option 615 to select a photo movie DVD media production format.

At step 325, the user transmits from the client 115 to the server 105 the user-supplied media content files and chosen media content theme settings describing the desired media production format. For example, the client 115 transmits descriptions of media content motions rather than the final animated frames. By the client 115 transmitting the user-supplied media content files and chosen media content theme settings, network bandwidth and disk storage is saved.

At step 330, a tangible media production such as a photo book, a photo movie DVD, and/or a video is produced. In one embodiment, a DVD production server is installed at a fulfillment facility, comprised of MPEG encoding, and/or DVD mastering and burning software and hardware, including standard DVD software tool libraries and/or a robotic production system. For example, in FIG. 8, a web client user orders a photo movie DVD using the photo movie DVD order graphical user interface 800, and the finished photo movie DVD is produced and delivered from the fulfillment facility. In an alternative embodiment, the DVD production server software can be installed on the same computer as the client, as in a standalone kiosk with integrated DVD burning hardware, in which case the finished photo movie DVD would be produced and delivered directly to the user from the kiosk's DVD hardware mechanism.

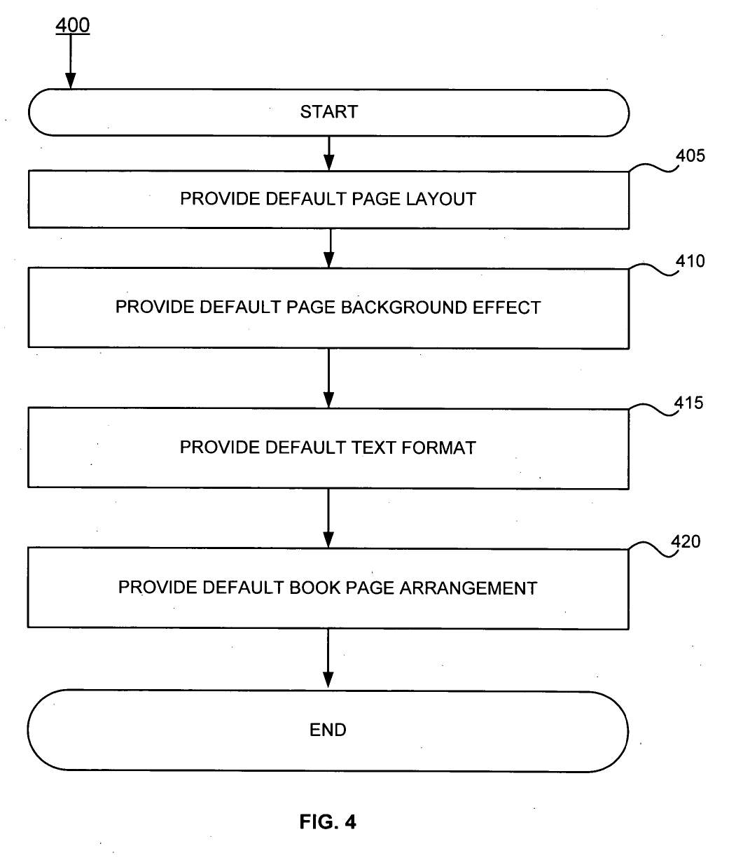

FIG. 4 shows an exemplary flowchart 400 for the application of media content default theme templates to a photo book media production. The media content default theme template module 245 (FIG. 2) provides a predefined set of aesthetically pleasing elements to the media content 220 to create a media production, such as a photo book.

At step 405, the media content default theme template module 245 provides a default page layout to the photo book. The default page layout is a default theme template for the placement of multiple items of media content 220 on a page of the photo book. The default page layout comprises predetermined positions and sizes for each item of media content 220, along with a ripple point that indicates the optimal number of items of media content 220 on the page for an automatic flow visual effect of the items of media content 220 into the photo book while the photo book is being viewed by the user.

At step 410, the media content default theme template module 245 provides a default page background effect to the photo book. The default page background effect is a default theme template for the background appearance of a particular page of the photo book. The default page background effect can include a background image, color tint settings, blur effect settings, a vignette outline image and/or other similar graphic elements to produce a background effect for a particular page of the photo book. Further, a user can elect to use one or more of their own items of media content 220 to create a page background effect.

At step 415, the media content default theme template module 245 provides a default text format to the photo book. The default text format is a default theme template for how text will appear on a particular page of the photo book. The default text format includes a predetermined text size, position, wrapping, font face, color, outline, shadow and/or glow effect for the text the user elects to use in the photo book.

At step 420, the media content default theme template module 245 provides a default book page arrangement to the photo book. The default book page arrangement is a default theme template for how one or more default page layouts (step 405), default page background effects (step 410) and default text formats (415) are provided to one or more pages of the photo book. For example, several possible default book page arrangements can be generated from the default page layouts, default background effects and default text formats and provided in a repeating sequence to make additional pages of the photo book for placement of additional items of media content 220. Further, a single default book page arrangement can be automatically flipped on each page of the photo book, to render a varying appearance effect for each page of the photo book.

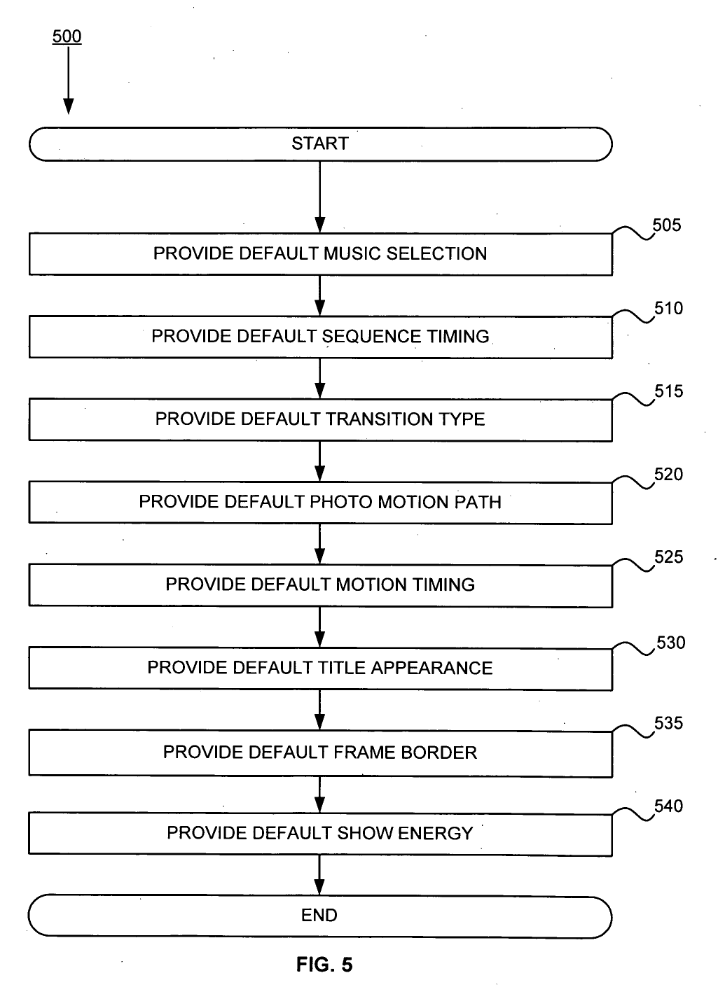

FIG. 5 shows an exemplary flowchart 500 for the application of media content default theme templates to a photo movie DVD or web slide show media production. The media content default theme template module 245 (FIG. 2) provides a predefined set of aesthetically pleasing elements to media content 220 (FIG. 2) to create a media production, such as a photo movie DVD or web slide show.

At step 505, the media content default theme template module 245 provides a default music selection to the photo movie DVD or web slide show. The default music selection is a default theme template for how one or more music files, or links to music files are applied to the photo movie DVD or web slide show.

At step 510, the media content default theme template module 245 provides a default sequence timing to the photo movie DVD or web slide show. The default sequence timing is a default theme template for how long each item of media content 220 appears on a viewer's screen or display device 210 (FIG. 2).

At step 515, the media content default theme template module 245 provides a default transition type to the photo movie DVD or web slide show. The default transition type is a default theme template for how each item of media content 220 will transition to another item or items of media content 220 in the timing sequence selected at step 510. Exemplary default transition types include a dissolving visual effect, wipes, 3D flying motions or similar transitions.

At step 520, the media content default theme template module 245 provides a default photo motion path to the photo movie DVD or web slide show. The default photo motion path is a default theme template for how an item of media content 220 is moved on the viewer's screen or display device 210, consisting of two or more animation control points with position, scaling and rotation data, resulting in a variety of documentary-style pan and zoom effects.

At step 525, the media content default theme template module 245 provides a default motion timing to the photo movie DVD or web slide show. The default motion timing is a default theme template for how the default photo motion path selected at step 520 is applied during the display of a particular item of media content 220 on the viewer's screen or display device 210. For example, the selected photo motion path can be slowly applied for the entire duration that a particular item of media content 220 appears on the viewer's screen or display device 210, or the selected photo motion path can be quickly applied for the entire duration the particular item of media content 220 appears on the viewer's screen or display device 210. Further, one or more default motion paths can be applied with appropriate motion acceleration and/or deceleration effects during the beginning, end or in the middle of the time that the particular item of media content 220 appears on the viewer's screen or display device 210, thus leaving the particular item of media content 220 stationary for the remaining duration of its time on the viewer's screen or display device 210.

At step 530, the media content default theme template module 245 provides a default title appearance to the photo movie DVD or web slide show. The default title appearance is a default theme template for how titles will appear on a particular item of media content 220. The default title appearance comprises one or more text boxes configured with a predetermined text size, position, wrapping, font face, color, outline, shadow, and glow effects. The default title appearance is applied during the display of the particular item of media content 220 on the viewer's screen or display device 210.

At step 535, the media content default theme template module 245 provides a default frame border to the photo movie DVD or web slide show. The default frame border is a default theme template for a frame border surrounding a media production. The default frame border comprises a frame border that places the edges of the media production beneath the frame border, thereby hiding the edges of the media production.

At step 540, the media content default theme template module 245 provides a default “show energy” effect to the photo movie DVD or web slide show. The default “show energy” effect is a default theme template applied at one or more of steps 510-535 for achieving a visual effect associated with or representative of a particular energy level associated with the photo movie DVD or web slide show. For example, the media content default theme template module 245 is configured to detect the overall beat or rhythm of the music applied to the photo movie DVD or web slide show at step 505. The media content default theme template module 245 is further configured to extrapolate from the detected beat or rhythm one or more of the default settings at steps 510-535 as described herein.

The media content default theme template module 245 can be manually overridden at any step of the process of applying default theme templates by the user executing commands and/or selecting menu options via one or more graphical user interfaces 250.

FIG. 6 through FIG. 13 show several exemplary graphical user interfaces 250 (FIG. 2). A client 115 (FIG. 1) communicates with a server 105 (FIG. 1) by a user executing a set of commands and/or menu options contained on one or more graphical user interfaces 250 that appear on the display device 210 of the client 115. The one or more graphical user interfaces 250 are implemented on the client 115 by using a combination of dynamic HTML and Active-X components to present commands, menu options, and system status to the user in an aesthetically pleasing and understandable format.

The one or more graphical user interfaces 250 are communicated from a graphical user interface communication module 255 (FIG. 2) that forms part of a digital media engine 200 (FIG. 2) that resides on the server 105. It will readily be appreciated by one of ordinary skill in the art that one or more graphical user interfaces similar to the graphical user interfaces depicted in FIG. 6 through FIG. 13 can be implemented and remain within the scope of embodiments of the present invention. Finally, although the two media production examples illustrated in FIG. 6 through FIG. 13 are for a photo movie DVD and a photo book, the graphical user interfaces illustrated and described herein can be adapted to produce other media production formats including, however not limited to, video, web slide shows, streaming media, or any other media production or printed medium comprised of media content.

Turning to FIG. 6, an exemplary photo movie DVD creation graphical user interface 600 is shown. The photo movie DVD creation graphical user interface 600 allows a user to create a photo movie DVD media production by presenting the user with a number of menu options and/or commands for selecting the items of media content 220 (FIG. 2) the user wishes to include in the media production. The photo movie DVD creation graphical user interface 600 includes commands and/or menu options such as media content selection icons 605; choose photos menu option 610; photos on DVD menu option 615; and media content playback commands 620 that permit the user to start, stop and pause the real-time playback of the media production featuring media content 220.

FIG. 7 shows an exemplary photo movie DVD add music graphical user interface 700. The photo movie DVD add music graphical user interface 700 allows a user to add music to a photo movie DVD media production by presenting the user with a number of menu options and/or commands for selecting music the user wishes to include in the media production. The photo movie DVD add music graphical user interface 700 includes commands and/or menu options such as music category menu options 705; add music menu option 710; import music command 715; and song selection icons 720.

FIG. 8 shows an exemplary photo movie DVD order graphical user interface 800. The photo movie DVD order graphical user interface 800 allows a user to order one or more copies of a photo movie DVD media production by presenting the user with a number of menu options and/or commands for ordering a photo movie DVD, including the ability to personalize the photo movie DVD with a title. The photo movie DVD order graphical user interface 800 includes commands and/or menu options such as photo movie DVD label title entry box 805; and photo movie DVD label title preview 810.

FIG. 9 shows an exemplary photo movie DVD media production editing graphical user interface 900. The photo movie DVD editing graphical user interface 900 allows a user to edit an item of media content 220 as a whole by rotating or cropping the entire item of media content 220, or to edit part of an item of media content 220 by blurring part or parts of the item of media content 220. The photo movie DVD editing graphical user interface 900 includes commands and/or menu options such as rotation editing menu option 905; and photo editing tools editing option 910.

FIG. 10 shows an exemplary photo movie DVD photo motion control graphical user interface 1000. The photo movie DVD photo motion control graphical user interface 1000 allows a user to control the motion of an item of media content 220 appearing in a media production by presenting the user with a number of possible motion options. The photo movie DVD photo motion control graphical user interface 1000 includes commands and/or menu options such as motion menu options 1005; photo motion editing option 1010; motion direction and depth controller 1015; and motion speed options 1020.

FIG. 11 shows an exemplary photo movie DVD text title control graphical user interface 1100. The photo movie DVD text title control graphical user interface allows a user to control the position and appearance of a text title as applied to an item of media content 220. The photo movie DVD text title control graphical user interface 1100 includes commands and/or menu options such as text title font size options 1105; text title entry box 1110; add text titles editing option 1115; text title vertical position options 1120; and text title horizontal position options 1125.

FIG. 12 shows an exemplary photo book creation graphical user interface 1200. The photo book creation graphical user interface 1200 allows a user to create a photo book media production by presenting the user with a number of menu options and/or commands for selecting a theme for a photo book. The photo book creation graphical user interface 1200 includes commands and/or menu options such as theme category submenu options 1205; theme category menu options 1210; and select a theme menu option 1215.

FIG. 13 shows an exemplary photo book page style graphical user interface 1300. The photo book page style graphical user interface 1300 allows a user to select a page style for a particular page of a photo book media production by presenting the user with a number of menu options and/or commands for selecting the page style for the particular page of the photo book. The photo book page style graphical user interface 1300 includes commands and/or menu options such as flip layout menu options 1305; page style submenu options 1310; change page style menu option 1315; and page style layout selection icons 1320.

The present invention is described above with reference to exemplary embodiments. It will be apparent to those skilled in the art that various modifications may be made and other embodiments can be used without departing from the broader scope of the present invention. Therefore, these and other variations upon the exemplary embodiments are intended to be covered by the present invention.

What is claimed is:

1. A networked media production system comprising:
a web server configured with a digital media engine;
the digital media engine configured with a media content default theme template module configured to provide at least one default theme template to media content;
a client with the media content, the client connected through an Internet connection to the web server;
the client configured to display the media content with the at least one default theme template provided by the media content default theme module; and
the client configured to transmit to the web server a media content file with media content theme settings.

2. The networked media production system of claim 1, further comprising the digital media engine configured with a media content resolution module configured to adjust resolution of the media content to accommodate a client display device.

3. The networked media production system of claim 1, further comprising the digital media engine configured with a media content real-time viewing module configured to display on a client display device an effect of an executed command or menu option shortly after the command or menu option has been executed.

4. The networked media production system of claim 1, further comprising the digital media engine configured with a media content storage module configured to store the media content file with media content theme settings transmitted over the Internet connection from the client.

5. The networked media production system of claim 4, further comprising the digital media engine configured with a media content cross-formatting module configured to apply information stored in the media content storage module with respect to one particular form of media production to create a second form of media production.

6. The networked media production system of claim 1, further comprising the digital media engine configured with a graphical user interface communication module configured to transmit one or more graphical user interfaces from the web server to the client.

7. A method for media production comprising:
selecting media content on a client;
providing one or more default themes to the media content;
selecting a media production format for the media content; and
transmitting the media content in a file with media content theme settings to a web server to produce a media production.

8. The method for media production of claim 7, further comprising editing the media content with a graphical user interface.

9. The method for media production of claim 8, further comprising viewing the edited media content on a client display device.

10. The method for media production of claim 9, further comprising storing the media content file with media content theme settings on the web server.
